(19) United States
(12) Patent Application Publication
(10) Pub. No.: US 2017/0008206 A1
(43) Pub. Date: Jan. 12, 2017

(54) Structural Molded Part, Motor Vehicle Fitting Element and Method for Producing a Structural Molded Part

(71) Applicant: Bayerische Motoren Werke Aktiengesellschaft, Muenchen (DE)

(72) Inventors: Christof SCHOENHAMMER, Leberweinting (DE); Bruno ROTH, Landshut (DE); Karl-Heinz STUMP, Altdorf (DE)

(21) Appl. No.: 15/269,766

(22) Filed: Sep. 19, 2016

Related U.S. Application Data
(63) Continuation of application No. PCT/EP2015/053769, filed on Feb. 24, 2015.

(30) Foreign Application Priority Data
Mar. 20, 2014 (DE) 10 2014 205 231.9

(51) Int. Cl. B29C 45/14; B29C 59/00; B29C 45/00

(52) U.S. Cl. CPC B29C 45/14475; B29C 45/1418; B29C 45/0005; B29C 59/007; B29C 2045/14245; B29K 2023/12

(57) ABSTRACT

A three-dimensional structural molded part is provided having one or more pre-formed organometallic sheet-metal parts each having at least one edge. The organometallic sheet-metal parts are connected at respective edges at least partly by an injection-molded plastics material.

### CROSS REFERENCE TO RELATED APPLICATIONS

This application is a continuation of PCT International Application No. PCT/EP2015/053769, filed Feb. 24, 2015, which claims priority under 35 U.S.C. §119 from German Patent Application No. 10 2014 205 231.9, filed Mar. 20, 2014, the entire disclosures of which are herein expressly incorporated by reference.

### BACKGROUND AND SUMMARY OF THE INVENTION

The present invention relates to a structural molded part, to a motor vehicle fitting element comprising such a structural molded part, and to a method for manufacturing a structural molded part.

In the motor vehicle industry, structural molded parts, such as instrument panels, door trims, center consoles, glove boxes and the like, are three-dimensional structures that are usually manufactured from polycarbonate acrylonitrile butadiene styrene (PC/ABS) by the injection-molding method. In order that sufficient stability and a good capability for filling the structural molded parts are obtained in simple manufacturing by means of injection-molding, the structural molded parts have to be manufactured to a wall thickness of at least 1.5 to approximately 4 mm or even 5 mm. This creates high costs for the materials, necessitating a high weight of the structural molded parts. So-called organopanels are semi-finished fibrous products that are impregnated with plastics material and are employed as inserts for stabilizing structural molded parts. The organopanels are laid up in a matrix of plastics material, or are overmolded by a matrix of plastics material. While, at least a slight weight reduction as compared with solid molded plastics parts is obtained, laying up and overmolding of organopanels is a complex process in which, besides the actual injection molding of the molded part, connecting the matrix of plastics material to the organopanel has to be considered.

It is an object of the present invention to provide a structural molded part that is distinguished by a simple structural design with very good strength and dimensional stability and, at the same time, by reduced dead weight. It is a further object of the invention to provide a motor vehicle fitting element which has high functionality, good interfacing options, and nevertheless low dead weight. It is a still further object of the invention to provide a method for manufacturing a structural molded part that is readily implementable without high technical complexity and enables the manufacturing of structural molded parts in volume production with low cycle times.

These and other objects are achieved by a structural molded part having one or a plurality of pre-formed organopanel parts, each having at least one edge. The organopanel parts are at least partially interconnected at the edges by an injection-molded plastics material. If, according to the invention, only one organopanel part is used, the organopanel has at least two edges. The organopanel part is then molded to a structural molded part such that at least these two edges are at least partially interconnected by an injection-molded plastics material. In the context of the invention an organopanel part is a two-dimensional textile structure containing fibers, which has been impregnated with a thermoplastic plastics material and which under the influence of forming energy, such as by pressing or deep-drawing, and under the influence of temperature may be pre-formed and formed to adapt a desired shape. The organopanel parts may comprise organometallic sheet-metal parts. While organopanels to date have only been used as an auxiliary part for stabilizing molded plastics parts in a localized manner, organopanel parts in the present invention form the decisive structural elements of the structural molded part according to the invention, substantially pre-defining the geometry of the structural molded part. A significant weight reduction is obtained not only by the use of the two-dimensional structure containing fibers but also by the usually minor wall thicknesses of the organopanels of preferably approximately 0.6 to 1.5 mm. The organopanel part or parts are only interconnected at the edges thereof by an injection-molded plastics material. A materially integral connection, which enables a durable stable arrangement of the organopanel parts, is formed between the organopanel parts by injection-molding the plastics material. The formation of a structural molded part with high strength and dimensional stability at low dead weight is supported by the similar chemical composition of the injection-molded plastics material and of the organopanel parts, each comprising a matrix of a plastics material. On account of the connection by way of the edges, the number and the arrangement of the organopanel parts is not limited in detail. This enables any desired geometry to be implemented in the structural molded part.

The dependent claims contain advantageous aspects and embodiments of the invention.

According to an aspect of the structural molded part according to the invention, at least one organopanel part contains polypropylene (PP) and/or long glass fibers and/or carbon fibers. The carbon fibers are preferably recycled carbon fibers. The advantage in using PP lies in that PP is distinguished by high availability and a favorable cost structure. Furthermore, on account thereof, a very good formation of a connection between the injection-molded plastics material and the organopanel part is promoted while a materially integral connection is molded. The use of long glass fibers, that is to say glass fibers preferably of 2 to 50 mm length, and/or of carbon fibers, and in particular recycled carbon fibers, contributes toward the stability of the structural molded part. The use of recycled carbon fibers increases the sustainability of the structural molded part and particularly contributes toward a favorable cost structure of said structural molded part. In order to further reduce costs, all organopanel parts employed preferably contain PP and/or recycled carbon fibers. Recycled carbon fibers in general may be harvested from carbon fiber manufacturing or from downstream processes of the carbon fiber manufacturing in semi-finished fibrous products manufacturing. Recycled carbon fibers accumulate as waste when semi-finished fibrous carbon products are being cut to size, for example.

Further advantageously, the injection-molded plastics material is a thermoplastic plastics material, preferably a plastics material containing polypropylene (PP). On account thereof, even better bonding of the organopanel parts is obtained since they likewise have a thermoplastic matrix of plastics material. Moreover, molding of the final geometry of the structural molded part may be performed simultaneously with connecting the organopanel parts at the edges thereof. Therefore, additional connection structures such as adhesive bonds or form-fitting connections are not mandatory. Also, PP is distinguished by high availability and a moderate cost structure.

One further advantageous aspect is characterized in that the injection-molded plastics material contains fibers, that is to say fibers and in particular long glass fibers, in particular having a fiber length from 2 to 50 mm, and/or carbon fibers, preferably recycled carbon fibers. Injection-molded plastics materials containing fibers are distinguished by significantly higher strength and rigidity. Moreover, long glass fibers and carbon fibers are distinguished by particularly high stability, in particular by high strength and dimensional rigidity at a very low dead weight. They are therefore particularly well suited for the structural molded part according to the invention. Moreover, the material costs of the structural molded part may be lowered by the use of recycled carbon fibers.

Further advantageously, in order for the visual impact of the structural molded part to be improved, at least one organopanel part preferably has on an internal side or on an external side, preferably on at least one visible side, a textile material. The textile material is preferably a PP/PET non-woven material, or else textile materials from polyamide or polypropylene. In order for the visual impact to be further improved, all visible sides of the organopanel parts are preferably provided with such a textile material.

In order for functionality to be increased and for fastening of the structural molded part according to the invention to be improved, at least one interface geometry and/or one functional geometry and/or one mounting are/is preferably disposed on at least one organopanel part. These elements serve for simplified installability and integration of the structural molded part into a surrounding geometry.

One further advantageous aspect provides that ribs from a plastics material, preferably from plastics material containing fibers, are molded on at least one organopanel part. The ribs serve for additional strengthening and reinforcement of the structural molded part, in particular in the case of molded parts which are mechanically stressed or are impinged by a load. The ribs are preferably molded thereon such that the ribs connect or reinforce the organopanel parts since particularly high rigidity and additionally good torsional stiffness may be obtained on account thereof.

A further aspect relates to a motor vehicle fitting element that comprises a structural molded part as described herein. An instrument panel, a door trim, a center console, or a glove box may be considered in particular as a motor vehicle fitting element, since these structural molded parts are very readily manufacturable with sufficiently good stability by forming one or a plurality of organopanel parts and by subsequently connecting the organopanel parts at the edges thereof by injection-molding methods. The motor vehicle fitting element according to the invention is distinguished by easy installability, high functionality, and nevertheless by very low dead weight.

A further aspect relates to a method for manufacturing a structural molded part, said method being distinguished by simple implementability without high technical and cost-related complexity. The method comprises the following acts:
forming one or more organopanel parts each having at least one edge;
laying up and arranging the formed organopanel part or parts in an injection-molding tool;
closing the injection-molding tool; and
at least partially interconnecting the organopanel part or parts at the edges by injection-molding a plastics material, in particular a thermoplastic plastics material containing fibers.

Further acts such as punching the organopanel parts, temperature-controlling the plastics material or the injection-molding tool, respectively, etc. may complete the method according to the invention. A stable materially integral connection of the organopanel parts is achieved in a very material-saving and thus cost- and weight-saving manner by injection-molding a plastics material for connecting one or a plurality of organopanel parts at the edges without using additional insert elements for stabilizing the structural molded part. In this way, the method according to the invention is distinguished by simple implementability of reduced complexity, and is highly suitable for production of structural molded parts in volumes at high cycle rates. For the purpose of further simplification, the plastics material is a thermoplastic plastics material containing fibers.

The advantageous effects, refinements, and advantages described in the context of the structural molded part according to the invention may also be applied to the motor vehicle fitting element according to the invention and to the method according to the invention.

A further aspect provides that at least one organopanel part is manufactured from polypropylene and/or long glass fibers, preferably with a length of 2 to 50 mm, and/or carbon fibers, and in particular recycled carbon fibers, and/or that the plastics material contains long glass fibers and/or carbon fibers, in particular recycled carbon fibers. Polypropylene may be very readily processed by means of an injection-molding method, and is distinguished by high availability and a favorable cost structure. A very high rigidity of the structural molded part is obtained by long glass fibers or carbon fibers. The costs for manufacturing the structural molded part additionally being able to be lowered by the use of recycled carbon fibers.

Further advantageously, the method comprises the act of applying a textile material, in particular a PP/PET non-woven material, or a textile material from polyamide or polypropylene, to an internal side or an external side, preferably to at least one visible side of at least one organopanel part. On account thereof, grains which have been incorporated by injection-molding and which may disadvantageously affect the visual impact of the structural molded part, for example, may be obscured. Applying such a textile material is performed in particular prior to forming the organopanel part, since all points which will later be visible may be included and be completely covered in this way. By using a textile material such as, in particular, a PP/PET non-woven material or a textile material from polyamide or polypropylene, the application of the textile material may be integrated into the forming process of the organopanel part, thus saving a separate act, for example flocking the structural molded part in a downstream act.

A further aspect is characterized by the further advantageous act of attaching at least one interface geometry and/or one functional geometry and/or one mounting to at least one organopanel part, on account of which the functionality of the structural molded part and integration of the structural molded part into surrounding geometries and structures is simplified. Attaching the functional elements may preferably likewise be performed in the injection-molding tool.

In order for rigidity, flexural stiffness, and torsional stiffness to be increased, the method is characterized by the further advantageous act of molding ribs on at least one organopanel part. Molding is advantageously carried out such that the ribs connect or reinforce the organopanel parts. Particularly, good stiffening of the structural molded part is performed in this way, in particular also in relation to torsion forces. Molding may again be advantageously performed in the injection-molding tool.

The following advantages result by virtue of the solutions according to the invention and the refinements thereof:
The structural molded part is distinguished by a simple structure with high functionality.
The structural molded part has high stability, rigidity, dimensional rigidity, and torsional stiffness.
The weight of the structural molded part is low.
Interface geometries, mountings, and functional elements are capable of ready integration.
The motor vehicle fitting element is highly functional, readily installable, and at the same time of low dead weight.
Manufacturing is readily implementable without high technical and cost-related complexity, even in the case of volume production at high cycle rates.

Other objects, advantages and novel features of the present invention will become apparent from the following detailed description of one or more preferred embodiments when considered in conjunction with the accompanying drawing.

### BRIEF DESCRIPTION OF THE DRAWING

FIG. 1 shows a schematic illustration of the manufacture of a structural molded part according to an advantageous refinement.

### DETAILED DESCRIPTION OF THE DRAWING

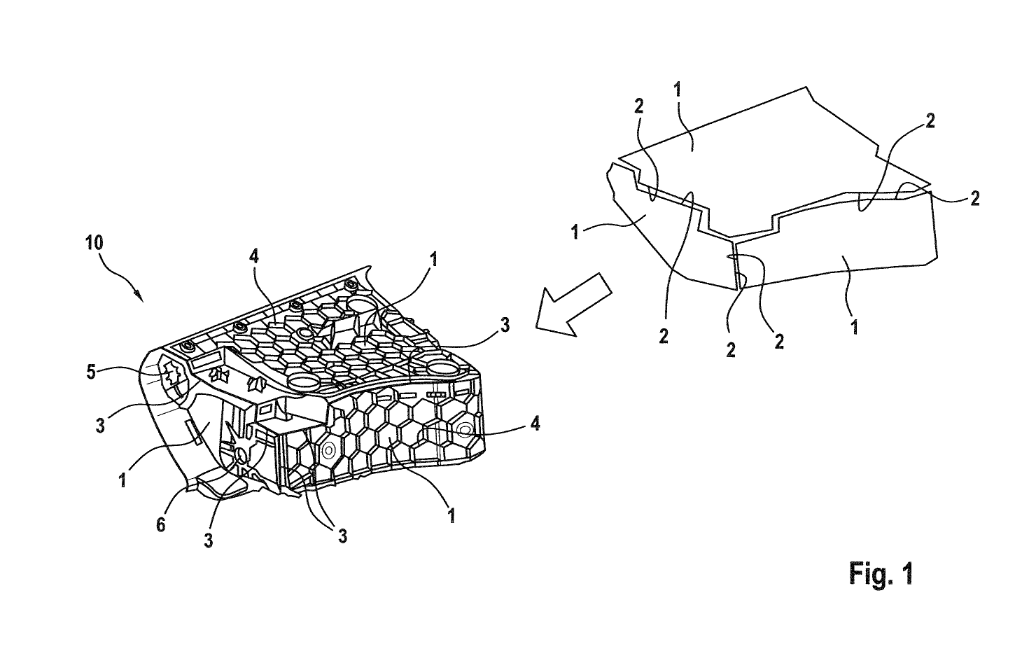

The present invention will be discussed in detail by means of an exemplary embodiment. Only those parts of the structural molded part according to the invention that are of immediate interest are illustrated in FIG. 1, all other elements being omitted for the sake of clarity. Furthermore, the same components are identified by the same reference sign.

FIG. 1 schematically shows the manufacture of a structural molded part 10, which in an exemplary manner is configured in the form of a glove box. Furthermore, the structural molded part 10 in an exemplary manner comprises three basic components which are formed by organopanel parts 1. The organopanel parts may be organometallic sheet-metal parts. The organopanel parts 1 are punched from large organopanels and are converted to the desired three-dimensional shape by forming, for example. Each organopanel part 1 has a plurality of edges 2. The organopanel parts 1 are then laid up in an injection-molding tool. Laying up and arranging the organopanel parts 1 is performed such that edges 2 of the organopanel parts 1 that are to be connected lie opposite one another. Upon closing of the injection-molding tool, a plastics-material injection molding compound, which comprises a preferably thermoplastic plastics material that preferably contains PP, is injected such that the plastics material adheres to the edges 2 of the organopanel parts 1. The mutually opposite organopanel parts 1 are thereby interconnected by way of the edges 2 of the organopanel parts 1. The plastics material here preferably covers the edges 2 on the entire length thereof. The reference sign 3 in FIG. 1 represents the connection of the organopanel parts 1 that is obtained upon termination of the plastics injection molding of the plastics material. It can be seen that the plastics-material connection 3 only covers the edges 2 of the pre-formed organopanel parts 1. A materially integral connection of the organopanel parts 1 is formed on account thereof on the edges 2 of the organopanel parts 1 by way of the plastics-material connection 3.

The injection-molded plastics material preferably contains fibers. The fibrous material of the injection-molded plastics material preferably contains glass fibers, preferably long glass fibers, preferably long glass fibers and/or carbon fibers and in particular recycled carbon fibers. The organopanel parts preferably comprise long glass fibers and/or carbon fibers, further preferably including recycled carbon fibers, that are incorporated into a matrix of polypropylene.

Moreover, the structural molded part 10 of FIG. 1 has reinforcement elements in the form of ribs 4. The ribs 4 preferably connect various organopanel parts 1, and serve for reinforcing the dimensional rigidity of the structural molded part 10. The ribs 4 are advantageously formed from the same plastics material as the plastics-material connection 3 of the organopanel parts 1.

For improved capability of interfacing and integration and for increased functionality, the structural molded part 10 additionally has at least one interface geometry 5 and one mounting 6. The structural molded part 10 may be complemented by further elements.

The preceding description of the present invention serves only for illustrative purposes and is not intended to limit the scope of the invention. Various alterations and modifications are possible in the context of the invention, without departing from the scope of the invention and the equivalents thereof.

### LIST OF REFERENCE SIGNS

1 Organopanel part

2 Edge of the organopanel part

3 Connection between the edges of the organopanel parts

4 Rib

5 Interface geometry

6 Mounting

10 Structural molded part

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A structural molded part comprising:
one or more organopanel parts, each organopanel part having one or more edges,
wherein at least one edge of the one or more organopanel parts is at least partially interconnected with at least one other edge of the one or more organopanel parts by an injection-molded plastics material.

2. The structural molded part of claim 1, wherein at least one organopanel part contains polypropylene and/or long glass fibers and/or carbon fibers.

3. The structural molded part of claim 2, wherein the carbon fibers are recycled carbon fibers.

4. The structural molded part of claim 1, wherein the injection-molded plastics material is a thermoplastic plastics material.

5. The structural molded part of claim 4, wherein the thermoplastics material contains polypropylene.

6. The structural molded part of claim 1, wherein the injection-molded plastics material contains fibers.

7. The structural molded part of claim 6, wherein the fibers are long glass fibers and/or carbon fibers.

8. The structural molded part of claim 7, wherein the carbon fibers are recycled carbon fibers.

9. The structural molded part of claim 1, wherein at least one organopanel part has a textile material on an internal side or on an external side.

10. The structural molded part of claim 1, wherein at least one organopanel part has a textile material on at least one visible side.

11. The structural molded part of claim 1, wherein an interface geometry and/or a functional geometry and/or a mounting is disposed on at least one organopanel part.

12. The structural molded part of claim 1, wherein ribs made of a plastics material are molded on at least one organopanel part such that the ribs connect or reinforce the organopanel parts.

13. A motor vehicle fitting element selected from one of: an instrument panel, a door trim, a center console, or a glove box, the motor vehicle fitting element comprising: the structural molded part of claim 1.

14. A method for manufacturing a structural molded part, the method comprising the following acts:
pre-forming one or more organopanel parts, each organopanel part having one or more edges;
laying up and arranging the one or more pre-formed organopanel parts in an injection-molding tool;
closing the injection-molding tool; and
at least partially interconnecting at least one edge of the one or more organopanel parts with at least one other edge of the one or more organopanel parts by injection-molding a plastics material.

15. The method of claim 14, wherein the plastics material is a thermoplastic plastics material containing fibers.

16. The method of claim 14, wherein
at least one organopanel part is manufactured from polypropylene and/or long glass fibers and/or recycled carbon fibers, and/or
the plastics material contains polypropylene and/or long glass fibers and/or recycled carbon fibers.

17. The method of claim 14, further comprising the act of:
applying a textile material to an internal side or an external side of the one or more organopanel parts prior to forming the organopanel part, wherein textile material is applied to at least one visible side of at least one organopanel part.

18. The method of claim 14, further comprising the act of:
attaching an interface geometry and/or a functional geometry and/or a mounting to at least one organopanel part.

19. The method of claim 14, further comprising the act of:
molding ribs on at least one organopanel part such that the ribs connect or reinforce the organopanel parts.
